(19) United States
(12) Patent Application Publication
(10) Pub. No.: US 2006/0186043 A1
(43) Pub. Date: Aug. 24, 2006

(54) Method and apparatus for sample deposition

(75) Inventors: Thomas Covey, Richmond Hill (CA); Peter Kovarik, Markham (CA)

Correspondence Address: BERESKIN AND PARR, 40 KING STREET WEST, BOX 401, TORONTO, ON, M5H 3Y2, CA

(73) Assignee: MDS Inc., doing business through it's MDS Sciex Division, Concord (CA)

(21) Appl. No.: 11/349,337

(22) Filed: Feb. 8, 2006

Related U.S. Application Data
(60) Provisional application No. 60/651,362, filed on Feb. 8, 2005.
(60) Provisional application No. 60/651,203, filed on Feb. 10, 2005.

(30) Foreign Application Priority Data
Feb. 9, 2005 (CA) 2,496,481

(51) Int. Cl. B01D 15/08

(52) U.S. Cl. 210/635; 210/656; 210/198.2; 210/259; 436/161; 436/178; 422/70

(57) ABSTRACT

A method and apparatus is disclosed to prepare a sample or a plurality of samples for subsequent analysis. A single sample deposition apparatus, and a multiplexed sample deposition apparatus are shown. The apparatus allows for a system that can provide a high throughput deposition of samples to form chromatograms by discrete droplet deposition or as continuous traces. The system can achieve high resolution digitization by pulsing the fluid emanating from the chromatographs by applying a voltage to the target plate that operates at frequencies equal to or greater than about 10 Hz, and up to and including about 1 KHz. The system also allows for analogue recording (i.e., approaching infinite resolution) by nebulizing the fluid coming from multiple columns and simultaneously collecting it on a target plate as a continuous trace.

This application claims the benefit of U.S. Provisional Application No. 60/651,362 filed Feb. 8, 2005, and also claims the benefit of U.S. Provisional Application No. 60/651,203 filed Feb. 10, 2005, and the entire contents of which are hereby incorporated by reference.

The section headings used herein are for organizational purposes only and are not to be construed as limiting the subject matter described in any way.

### FIELD

Applicant's teachings relate to a method and apparatus of sample deposition for subsequent analysis, by, for example, mass spectrometry. In particular, applicant's teachings can provide high-throughput sample deposition for subsequent analysis by MALDI mass spectrometry.

### INTRODUCTION

Liquid chromatography (LC) is a widely used separation process that relies on the differential absorption properties of organic molecules. Typically an organic mixture in a specific solvent (eluant) is added to the top of a chromatography column that has been packed with an absorbent material onto which compounds may be absorbed. As the eluant and the solute mixture descend through the column the more strongly absorbed compounds coat the absorbent material, referred to as the stationary phase. The less strongly absorbed compounds proceed through the column along with the eluant. The compounds are therefore separated based on retention times so that compounds that interact strongly with the stationary phase are retained for a longer period in the column. The eluted separated components of the mixture are discharged from the other end of the chromatography column along with the eluant. Properly separated, the organic compounds come out of the column at intervals spaced by relatively pure eluant.

High Performance Liquid Chromatography (HPLC) refers to the separation of compounds under high pressure in a chromatography column. Typically, HPLC uses a pump system to pump the eluant through the chromatography columns. The pump systems typically comprise a reservoir that receives a small amount of fluid (usually solvent or water that will form the eluant) from a source. A piston is operably displaceable within the reservoir to pump the fluid from the reservoir to the chromatography column. The piston is typically driven by a step-motor.

The action of the piston causes the fluid to be discharged from the reservoir at a discontinuous flow rate and usually results in pressure pulses of fluid flow. To help smooth the discharge flow rate the pump system includes a dampening chamber, which acts like a shock absorber to the pulses of fluid flow. Typically the dampening chamber is of large volume relative to the fluid flow. In typical HPLC, each pump actually comprises two similar pumps operating 180° out of phase, with one of the pumps introducing a solvent and the other pump introducing, generally water, which are mixed downstream of the pumps to form the eluant that flows through the chromatography columns.

Moreover, liquid chromatography can be used to deposit separated analytes on a target plate for subsequent analysis. These sample records can be stored for months under appropriate conditions, allowing for characterization of additional species in subsequent experiments without additional sample processing.

The separation capability of liquid chromatography make it a useful tool to prepare samples for subsequent analysis of complex mixtures, such as, but not limited to, compounds often found in pharmaceutical drug discovery and development, proteomics, forensics, environmental science, and clinical medicine.

Mass spectrometry is a prevalently used analytical method that identifies molecules in compounds based on the detection of the mass-to-charge ratio of ions generated from molecules that have been electrically charged.

Numerous methods exist to ionize molecules that are then analyzed by mass spectrometry. One such method, a soft ionization method used to determine masses of easily fragmented analytes, is matrix-assisted laser desorption ionization (MALDI). In MALDI, samples are mixed with a UV-adsorbing compound known as a matrix, deposited on a surface, and ionized with a fast laser pulse. The energy of the laser is absorbed by the matrix molecules and transferred to the sample molecules, causing them to vaporize and ionize. The ions are then analyzed by a mass spectrometer, such as, for example, but not limited to, a time-of-flight (TOF) mass spectrometer.

To adequately address the need for the rapid and efficient analysis of compounds by, for example, but not limited to, MALDI mass spectrometry, without compromising accuracy and chromatographic fidelity, a comprehensive, high throughput method and apparatus, for example, a multiplexed system, to deposit samples efficiently utilizing the capabilities of liquid chromatography, is required.

### SUMMARY

The applicant's teachings provide for a method of depositing a sample for analysis. The method comprises flowing a suitable eluant through a chromatographic column for separating a sample, discharging from the chromatographic column the eluant with eluted separated components of the sample, the eluant forming a droplet at the discharge end of the chromatographic column, providing a suitable deposition surface spaced from the discharge end of the chromatographic column to receive the droplet, and applying a voltage to the deposition surface to pull the droplet to the deposition surface, the voltage applied to the deposition surface at a frequency generally equal to or greater than 10 Hz. The voltage can be applied to the deposition surface at a frequency up to and including generally 1 kHz.

Moreover, applicant's teachings provide for a method of depositing multiple samples for analysis. The method comprises flowing suitable eluants through respective multiple chromatographic columns, each column for separating a sample, discharging from the multiple chromatographic columns the eluants with eluted separated components of the samples, the eluants forming droplets at the discharge ends of the respective chromatographic columns, providing at least one suitable deposition surface spaced from the discharge ends of the chromatographic columns to receive the droplets, and applying a voltage to the deposition surface to pull the droplets to the deposition surface, the voltage applied to the deposition surface at a frequency generally equal to or greater than 10 Hz. The voltage can be applied to the deposition surface at a frequency up to and including generally 1 kHz.

In the various embodiments, the voltage can be applied to the deposition surface so that successive droplets are pulled to corresponding target locations on the deposition surface. The deposition surface can be movable relative to the discharge end of the chromatographic column.

The applicant's teachings also provide for a method of depositing multiple sample for analysis, wherein the method comprises flowing suitable eluants through multiple chromatographic columns, each column for separating a sample, discharging from the multiple chromatographic columns the eluants with eluted separated components of the samples, nebulizing the discharged eluants, and depositing the nebulized eluants on at least one suitable deposition surface to produce chromatograms.

Further, in the various embodiments, at least one pneumatic pump is used to flow the suitable eluant through the chromatographic column. Moreover, the eluant flow rate can be controlled by a flow meter in combination with a control processor, the eluant flow rate measured and controlled to provide continuous control of the flow rate. In the various embodiments, the eluant flow rate is a mixture of two fluid flows, with the flow rate of each fluid flows controlled by a respective flow meter in combination with a control processor. At least one of the fluid flows can be water; the other of the fluid flows can be a solvent.

In the various embodiments where multiple chromatographic columns are used, a plurality of pneumatic pumps can be provided, and at least one pump is associated with each respective chromatographic column.

In the various embodiments where the discharged eluants are nebulized, a stream of non-reactive gas can nebulize the discharged eluant. The non-reactive gas can be nitrogen.

In various embodiments, the method can comprise introducing a matrix to the sample, where the matrix is suitable for use in matrix-assisted laser desorption ionization. The matrix can be introduced to the eluants before the step of nebulizing the discharged eluants.

In various embodiments, the discharged eluants can be heated.

Moreover, in the various embodiments where the discharged eluants are nebulized, the chromatograms can be continuous traces, which, in some embodiments can be parallel to one another. Moreover, each continuous trace can correspond to a discharge from a respective chromatographic column. Further, all or a portion of the chromatograms can be ionized by a laser, and the laser can produce at least one track on the continuous trace of a select chromatogram. The laser can be a high-speed laser, and each chromatogram can be rastered at a constant velocity. Further in some embodiments, the multiple laser tracks can be produced on the continuous trace of the select chromatogram. Moreover, in some embodiments, multiple laser passes can be made on a single track produced on the continuous trace of a selected chromatogram.

Applicant's teachings also provide for an apparatus to prepare a sample for analysis. The apparatus comprises a chromatographic column to receive a sample with a suitable eluant, a pump to flow the eluant through the chromatographic column, a suitable deposition surface, the deposition surface spaced from a discharge end of the chromatographic column to receive a droplet formed at the end thereof by the flow of eluant through the chromatographic column, and a power supply to generate a voltage on the deposition surface to pull the droplets to the deposition surface, the voltage applied to the deposition surface at a frequency generally equal to or greater than 10 Hz. The voltage can be applied to the deposition surface at a frequency up to and including generally 1 kHz.

Moreover, applicant's teachings provide for an apparatus to prepare multiple samples for analysis. The apparatus comprises multiple chromatographic columns to receive at least one sample with a suitable eluant, a plurality of pumps, with each pump associated with each chromatographic column, the pump to flow the eluant through the chromatographic column, the pump further including a flow meter and control processor to provide continuous control of the eluant flow rate, at least one suitable deposition surface, the deposition surface spaced from multiple discharge ends of the respective chromatographic columns, the at least one suitable deposition surface to receive droplets formed at the ends thereof by the flow of eluants through the respective chromatographic columns, and at least one power supply to generate a voltage on the deposition surface to pull the droplets to the deposition surface, the voltage applied to the deposition surface at a frequency generally equal to or greater than 10 Hz. The voltage can be applied to the deposition surface at a frequency up to and including generally 1 kHz.

Further, for the various embodiments disclosed the power supply can apply a voltage to the deposition surface so that successive droplets are pulled to corresponding target locations on the deposition surface. The deposition surface can be movable relative to the discharge end of the chromatographic column.

In the various embodiments, the pump can be a pneumatically driven pressure amplifier pump. The pump can comprise a flow meter and control processor to provide continuous control of the eluant flow rate. Moreover, the pump can comprise a pressure source sized to hold a volume of eluant greater than the volume of the chromatographic column.

Moreover, for the various embodiments a nebulizer can be provided to introduce a nebulizing gas to the chromatographic column, the nebulizer nebulizing the flow of eluant as it is discharged. The nebulizing gas can be a non-reactive gas. The non-reactive gas can be nitrogen.

Further, for some embodiments where multiple chromatographic columns can be provided, the nebulizer can comprise a first manifold connected to the multiple chromatographic columns to introduce the nebulizing gas to the chromatographic columns, the nebulizer nebulizing the flow of eluant as it is discharged. The first manifold can be connected to the multiple chromatographic columns by T-valves. Morever, the apparatus can comprise multiple deposition capillaries operably connected to the respective T-valves to discharge the nebulized eluants from the respective multiple chromatographic columns. In various embodiments, the nebulizer can comprise a pump to deliver the nebulizing gas to the multiple chromatographic columns. The pump can comprise a pneumatic pump.

Further, in various embodiments, a matrix delivery system can be provided to introduce a matrix to the eluant, the matrix suitable for use in matrix-assisted laser desorption ionization. For some embodiments where a nebulizer can be used to nebulize the flow of eluants as they are discharged, the matrix delivery system can deliver the matrix to the eluant before the eluant is nebulized.

For some embodiments where multiple chromatographic columns can be provided, a matrix delivery system can be provided, the matrix delivery system including a second manifold connected to the multiple chromatographic columns, the second manifold to introduce a matrix to the eluants, the matrix suitable for use in matrix-assisted laser desorption ionization. The second manifold can be connected to the multiple chromatographic columns by T-valves. The second manifold can be operably connected to respective multiple chromatographic columns to deliver the matrix before the eluant is nebulized. Moreover, the matrix delivery system can comprise a pump to deliver the matrix to the multiple chromatographic columns. In some embodiments the pump can be a syringe pump. In some embodiments the pump is a continuous flow pump.

In various embodiments the apparatus can comprise a translational stage to receive the at least one depostion surface. The translation stage can be displaceable relative to the multiple chromatographic columns so that the multiple chromatograms produced are in parallel to one another. Further, the at least one deposition surface can be a plurality of plates arranged in a deposition array on the translational stage.

Applicant's teachings also provides for an apparatus to prepare multiple samples for analysis, the apparatus comprising multiple chromatographic columns to receive at least one sample with a suitable eluant, a plurality of pumps, with each pump associated with each chromatographic column, a nebulizer to introduce a nebulizing gas to the multiple chromatographic columns, the nebulizer nebulizing the flow of eluants as they are discharged, and at least one suitable deposition surface to receive the discharged nebulized eluants, the discharged nebulized eluants from the multiple chromatographic columns producing respective multiple chromatograms on the at least one suitable deposition surface.

In the various embodiments, the pump can be a pneumatically driven pressure amplifier pump. The pump can comprise a flow meter and control processor to provide continuous control of the eluant flow rate. Moreover, the pump can comprise a pressure source sized to hold a volume of eluant greater than the volume of the chromatographic column.

Moreover, for the various embodiments a nebulizer can be provided to introduce a nebulizing gas to the chromatographic columns, the nebulizer nebulizing the flow of eluant as it is discharged. The nebulizing gas can be a non-reactive gas. The non-reactive gas can be nitrogen.

The nebulizer can comprise a first manifold connected to the multiple chromatographic columns to introduce the nebulizing gas to the chromatographic columns, the nebulizer nebulizing the flow of eluant as it is discharged. The first manifold can be connected to the multiple chromatographic columns by T-valves. Morever, the apparatus can comprise multiple deposition capillaries operably connected to the respective T-valves to discharge the nebulized eluants from the respective multiple chromatographic columns. In various embodiments, the nebulizer can comprise a pump to deliver the nebulizing gas to the multiple chromatographic columns. The pump can comprise a pneumatic pump.

Further, in various embodiments, a matrix delivery system can be provided to introduce a matrix to the eluant, the matrix suitable for use in matrix-assisted laser desorption ionization. For some embodiments where a nebulizer can be used to nebulize the flow of eluants as they are discharged, the matrix delivery system can deliver the matrix to the eluant before the eluant is nebulized.

The matrix delivery system can include a second manifold connected to the multiple chromatographic columns, the second manifold to introduce a matrix to the eluants, the matrix suitable for use in matrix-assisted laser desorption ionization. The second manifold can be connected to the multiple chromatographic columns by T-valves. The second manifold can be operably connected to respective multiple chromatographic columns to deliver the matrix before the eluant is nebulized. Moreover, the matrix delivery system can comprise a pump to deliver the matrix to the multiple chromatographic columns. In some embodiments the pump can be a syringe pump. In some embodiments the pump is a continuous flow pump.

In various embodiments the apparatus can comprise a translational stage to receive the at least one depostion surface. The translation stage can be displaceable relative to the multiple chromatographic columns so that the multiple chromatograms produced are in parallel to one another. Further, the at least one deposition surface can be a plurality of plates arranged in a deposition array on the translational stage.

In some embodiments, the apparatus can comprise at least one power supply to generate a voltage on the deposition surface to pull the droplets to the deposition surface, the voltage applied to the deposition surface at a frequency generally equal to or greater than 10 Hz. The voltage can be applied to the deposition surface at a frequency up to and including generally 1 kHz. The power supply can apply a voltage to the deposition surface so that successive droplets are pulled to corresponding target locations on the deposition surface.

Further, applicant's teachings provide for a system to prepare multiple samples for analysis through either droplet deposition or by nebulizing, depending on use. The system comprises multiple chromatographic columns to receive at least one sample with a suitable eluant, a plurality of pumps, with each pump associated with each chromatographic column, a nebulizer to introduce a nebulizing gas to the multiple chromatographic columns, the nebulizer nebulizing the flow of eluants as they are discharged, at least one suitable deposition surface to receive the discharged nebulized eluants, the discharged nebulized eluants from the multiple chromatographic columns producing respective multiple chromatograms on the at least one suitable deposition surface, and at least one power supply to generate a voltage on the deposition surface to pull the droplets to the deposition surface, the voltage to be applied to the deposition surface at a frequency generally equal to or greater than 10 Hz. The voltage can be applied to the deposition surface at a frequency up to and including generally 1 kHz.

In various embodiments the power supply can apply a voltage to the deposition surface so that successive droplets are pulled to corresponding target locations on the deposition surface.

In various embodiments, the pump to flow the eluant through the chromatographic column can comprise a flow meter and control processor to provide continuous control of the eluant flow rate. The pumps can be pneumatically driven pressure amplifier pumps. The pumps can further comprise a pressure source sized to hold a volume of eluant greater than the volume of the respective chromatographic column.

In various embodiments, the nebulizer can comprise a first manifold connected to the multiple chromatographic columns to introduce the nebulizing gas to the respective chromatographic columns. The first manifold can be connected to the multiple chromatographic columns by T-valves. Further, in various embodiments the system can comprise multiple deposition capillaries operably connected to respective T-valves to discharge the nebulized eluants from the respective multiple chromatographic columns. The nebulizer can comprise a pump to deliver the nebulizing gas to the multiple chromatographic columns. The pump can be a pneumatic pump.

The nebulizing gas can be a non-reactive gas. The non-reactive gas can be nitrogen.

Moreover, in various embodiments, the system can comprise a matrix delivery system, that can include a second manifold connected to the multiple chromatographic columns, the second manifold to introduce a matrix to the eluants, the matrix suitable for use in matrix-assisted laser desorption ionization. The second manifold can be connected to the multiple chromatographic columns by T-valves. The second manifold can be operably connected to respective multiple chromatographic columns to deliver the matrix before the eluant is nebulized. The matrix delivery system can comprise a pump to deliver the matrix to the multiple chromatographic columns. For some embodiments the pump can be is a syringe pump. For some embodiments the pump can be a continuous flow pump.

In various embodiments, the system can comprise a translational stage to receive the at least one deposition surface, the translation stage displaceable relative to the multiple chromatographic columns so that the multiple chromatograms produced are in parallel to one another. The at least one deposition surface can be a plurality of plates arranged in a deposition array on the translational stage.

These and other features of the applicant's teachings are set forth herein.

### DRAWINGS

The skilled person in the art will understand that the drawings, described below, are for illustration only. The drawings are not intended to limit the scope of the applicant's teachings in any way.

FIGS. 1a and 1b are schematic views, respectively, of a single and multiplexed sample deposition apparatus of applicant's teachings;

FIG. 2 is a flow chart illustrating fluid flow to the chromatography column;

FIGS. 3a and 3b are graphs comparing a conventional flow profile to the flow profile of the fluid flow of the system illustrated in FIG. 2;

FIG. 4 is a diagram showing discrete sample deposition;

FIGS. 5a and 5b, are graphs comparing detectability and throughput of conventional systems to those of applicant's teachings;

FIG. 5c is a graph of detectability of separations of minoxidil and reserpine using applicants teachings;

FIG. 6 is a schematic showing a delivery system for a nebulizing gas using applicant's teachings;

FIG. 7 is a schematic illustrating deposition of discharged multiple eluants to a target plate to create multiple chromatograms;

FIG. 8 is an enlarged view of a portion of a chromatogram and showing a laser track;

FIG. 9 is an enlarged view of a portion of a chromatogram and showing multiple laser tracks;

FIG. 10 is an enlarged view of a portion of a chromatogram and showing a multiple laser passes over the same laser track;

FIG. 11 is a chart showing the reproducibility of mass spectrometry analysis of a select chromatogram when using multiple laser passes over the same laser track; and

FIGS. 12a, 12b, and 12c, are charts illustrating detection limit enhancements by summing multiple laser passes over the same laser track.

### DESCRIPTION OF VARIOUS EMBODIMENTS

The following description is meant to be illustrative only and not limiting. Various embodiments of applicant's teachings will be apparent to those of ordinary skill in the art in view of this description.

Applicant's teachings relates to a method and apparatus of sample deposition for subsequent analysis, by, for example, but not limited to, matrix-assisted laser desorption ionization (MALDI) mass spectrometry.

High Performance Liquid Chromatography (HPLC) chromatographic separation represents a rate-limiting step in any mass spectrometry based sample analysis. In the fields of proteomics and drug discovery increasingly large numbers of samples need to be analyzed to solve biologically meaningful problems. In proteomics 2-dimensional LC is becoming essential to resolve highly complex samples. In a 2-dimensional experiment 10 to 100 fractions would be collected from the first separation step and each individual fraction would then be subjected to another stage of chromatography. The time required performing this analysis in a serial fashion becomes practically prohibitive unless the chromatography in the second dimension can be multiplexed. Similarly for drug discovery applications where large batteries of invitro tests of drug candidates are being used to predict drug efficacy, the chromatographic separation step represents the analysis bottleneck and a need for multiplexed chromatographic separations followed by high speed MALDI mass spectrometry would represent a breakthrough in the discovery process.

Conventional HPLC equipment is not readily amenable to multiplexing. The mechanical complexity, size, and cost make it practically prohibitive. A fluid delivery system based on pneumatic gas pressure as the driving force for the fluids is mechanically simple, small, and inexpensive. These factors allow for multiple pneumatic pumps to be arrayed in an instrument to provide independent flow control to any number of independent channels. Attempts to deliver fluids to multiple chromatographic channels from a single pumping source require flow splitting to distribute the fluids. In practice this approach is problematic due to differential pressures building up in the individual chromatographic channels resulting in uncontrolled divergence of the flow rates in the different channels. A pumping system that provides an independent pumping arrangement for each individual chromatographic channel is required to create a robust reliable multidimensional separation system.

For such an instrument to function reliably as a system a means for depositing the chromatographic effluent onto MALDI targets must be created that can readily accommodate the simultaneous deposition of multiple channels without unnecessary mechanical complexity and stringent dimensional tolerances. The momentary and simultaneous application of a high voltage over an array of MALDI targets serves this purpose well. A single power supply pulsing the entire target array provides the droplet generating force, all channels being in perfect synchrony. Dimensional differences between the various droplet-emitting capillaries relative to the high voltage target are irrelevant because a field can be used to assure a sufficient force will be applied to all capillaries despite differences in their spacing from the target. No mechanical or moving parts are required to expel the droplets, which would introduce prohibitive complexity to a multiplexed system. Pumping systems such as this one are capable of delivering high speed and high fidelity gradients resulting in high resolution chromatographic traces. To obtain high definition profiling of chromatographic traces, high frequency and small droplet volumes must be expelled from the capillaries in a simultaneous fashion. Frequencies greater than or equal to 10 Hz and up to and including about 1 kHz, and droplet volume as low as 10 picoliters, will likely be required as chromatographic resolutions increase. Mechanically touching capillaries to a surface to release the droplets, in particular in a multiplexed fashion, would not be possible at these speeds.

Piezo, ultrasound, and inkjet devises are inappropriate as dispensers of liquid from a chromatographic columns because of the excessive liquid volumes these devices contain which degrade the chromatographic separations by virtue of band spreading in the large volume chambers of these devises. The devise described here requires no reservoir of liquid to effect droplet dispensation.

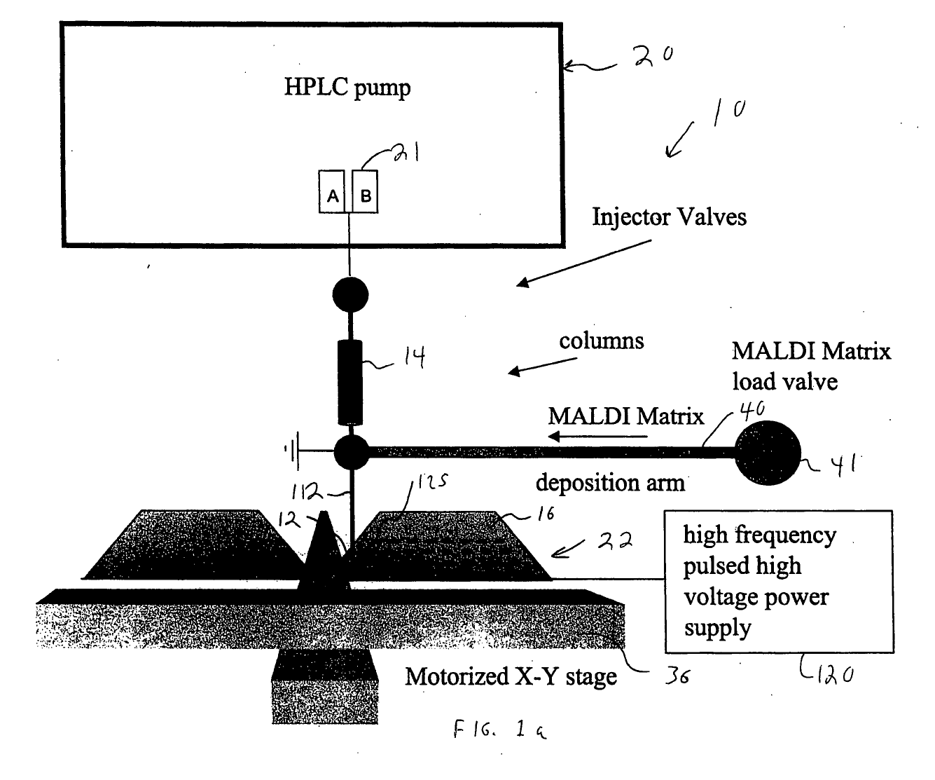

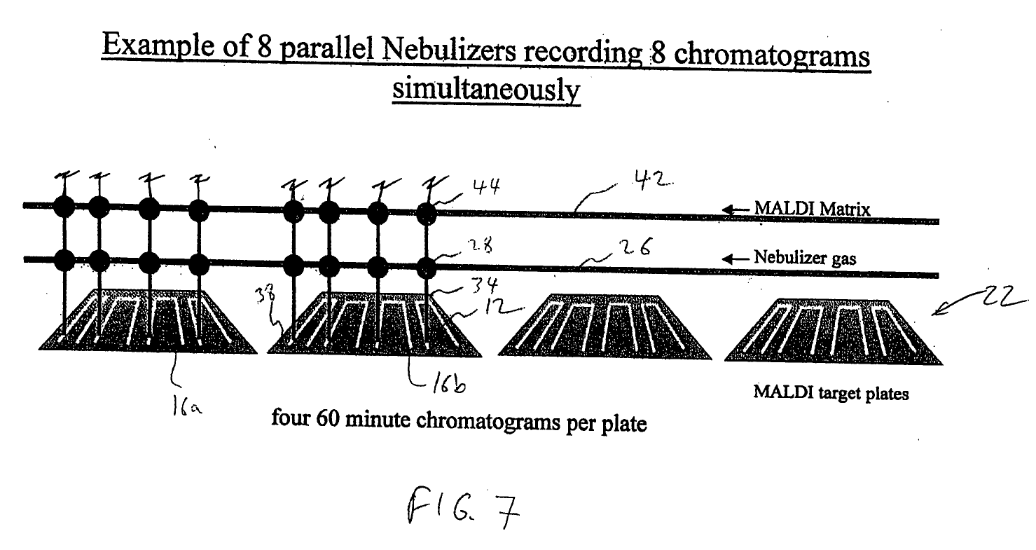

Referring to FIGS. 1a and 1b, an apparatus 10 to prepare a sample or a plurality of samples for subsequent analysis are shown. In particular, FIG. 1a shows an example of a single sample deposition apparatus of applicant's teachings and FIG. 1b shows an example of a multiplexed sample deposition apparatus of applicant's teachings. Like reference characters will be used to refer to the same components in the various aspects. The apparatus 10 can provide a high throughput deposition of samples to form chromatograms 12, by, for example discrete droplet deposition, as illustrated in FIGS. 1a and 1b, for some aspects of applicant's teachings, and, as will hereinafter be explained, as continuous traces, as illustrated in FIG. 7, for some aspects of applicants teachings.

The apparatus 10 includes a sample delivery system, such as, for example, but not limited to, an autosampler (not shown). The delivery system simultaneously introduces a sample (not shown) with suitable eluant into a channel fluid delivery system, comprising a pumping system, shown generally at 20, to push the eluant through a chromatographic column 14 for deposition on a suitable deposition surface 16. For the various aspects of applicant's teaching, for example only, as shown in FIG. 1a, the eluant is pushed through a single chromatographic column 14; for some aspects, for example only, as shown in FIG. 1b, the eluant is pushed through a plurality of chromatographic columns 14.

Continuing to refer to FIGS. 1a and 1b, the deposition surface 16 can be provided in a deposition array 22. Two deposition surfaces 16 are provided in an array 22 for purposes of illustration of applicants teachings shown in FIGS. 1a and 1b; four deposition surfaces 16 are provided in an array 22 for purposes of illustration for some aspects of applicant's teachings, for example only, as shown in FIG. 7. It is to be understood that the deposition surfaces can be arranged in an array of n×n deposition surfaces as desired. The array 22 of deposition surfaces can be provided on a translational stage 36, such as an x-y-z stage, as will hereinafter be explained. Providing an array 22 of deposition surfaces on a translational stage 36 facilitates the high throughput deposition of the chromatograms 12 for multiplexed systems shown in FIG. 1b, as will hereinafter be explained.

For some aspects, for example only as shown in FIG. 1b, at least one sample is introduced with a suitable eluant into multiple chromatographic columns 14. It can be appreciated, however, that some aspects of applicant's teachings contemplate one sample divided amongst the multiple chromatographic columns 14 to produce multiple chromatograms 12 of the same sample for analysis, as well as each chromatographic column 14 receiving a separate sample with suitable eluant, and various combinations of these as needed.

To achieve high throughput, the pumping system 20 needs to provide precise gradients at nanoliter per minute rates and respond rapidly to flow rate changes, and particularly for each chromatographic column 14 as shown in FIG. 1b. A suitable pump that has these characteristics is a pneumatic pump such as a pneumatically driven pressure amplifier pump. It is to be understood however, that other pumping systems that achieve similar results are contemplated for use with applicant's teachings.

As illustrated in FIG. 1b, the pumping system 20 has a pump 21 associated with each chromatographic column 14. The pumps 21 of the pumping system 20 precisely measure flow rates and control flow of the eluants through respective chromatographic columns 14. This allows the pumps 21 to quickly respond to step changes in flow rates, pump against substantial back pressures, identify leaks and blockages, and adjust flow rates accordingly in the respective chromatographic columns 14 of FIG. 1b, on a one-to-one basis.

By providing a pump 21 on on-to-one basis with a respective chromatographic column applicant's teachings achieves multiplexing that avoids flow splitting and the disadvantages associated with flow splitting. For example, flow-splitting systems utilize one pump that splits the flow into multiple chromatographic columns. However, it is known that, for example, back pressures, leaks and blockages, can occur at different rates and times within each chromatographic column. Therefore any measure of the flow rate and control of the flow by the pump would be applied to all of the chromatographic columns in a flow-splitting system, which, as can be appreciated might result in not enough flow for a given column, or alternatively, might be too much flow for a given column. Multiplexing systems that use flow splitting do not provide for precise measuring of the flow rates and control of the flow of the eluants through respective chromatographic columns on a one-to-one basis as shown in FIG. 1.

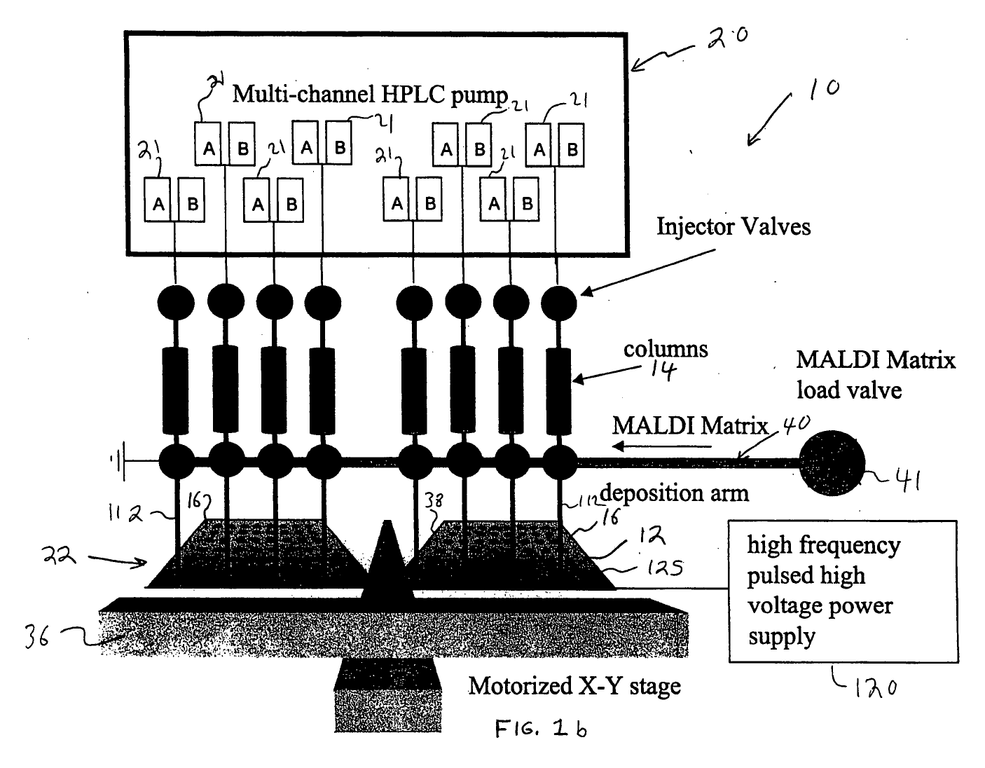

FIG. 2 illustrates a suitable pump 21 for various embodiments of applicant's teachings. As will hereinafter be explained, pump 21 is actually two pumps 21A and 21B that combine their respective fluid flows, however, for purposes of applicant's teachings, pumps 21A and 21B operate identically.

Pump 21A and 21B feature a source 102a, 102b, respectively, of a large volume of fluid (such as solvent or water) and a discharge channel 104a, 104b, respectively, connected to the source and through which the fluid travels to the chromatographic column 14 associated with that pump. The fluid can be pneumatically driven from the source 102a, 102b, where the pump 21 is a pneumatic pump, for example. Typically, the fluids retained in the sources 102a, 102b are sufficient in volume to feed the respective chromatographic column 14 for the entire desired run.

Flow meters 106a, 106b are provided in channels 104a, 104b, respectively. Flow meters 106a, 106b measure the flow rates of the fluids through channels 104a, 104b, respectively. The fluid flow rates measured by the flow meters 106a, 106b, are monitored by control processors 108a, 108b, respectively, which then adjust the discharge of the fluids from sources 102a, 102b, respectively. By monitoring the fluid flow with a suitable control processor, microfluidic flow control is precise and rapid to generate the desired flow through a given chromatographic column 14. Preferably, pump 21 can provide flow rates from 1 nl per minute to 100 μl per minute.

As previously mentioned, pump 21 comprises two pumps 21A and 21B to deliver the suitable fluids to a liquid chromatography column 14. Pump 21A, for example, operates to dispense a suitable fluid, such as water, to the liquid chromatography column 14. Water can serve to both flush the column for cleaning, as well as to dilute the solvent. Pump 21B, can operate to pump a suitable solvent to the liquid chromatography column 14 to effect the separation of the compounds within the column.

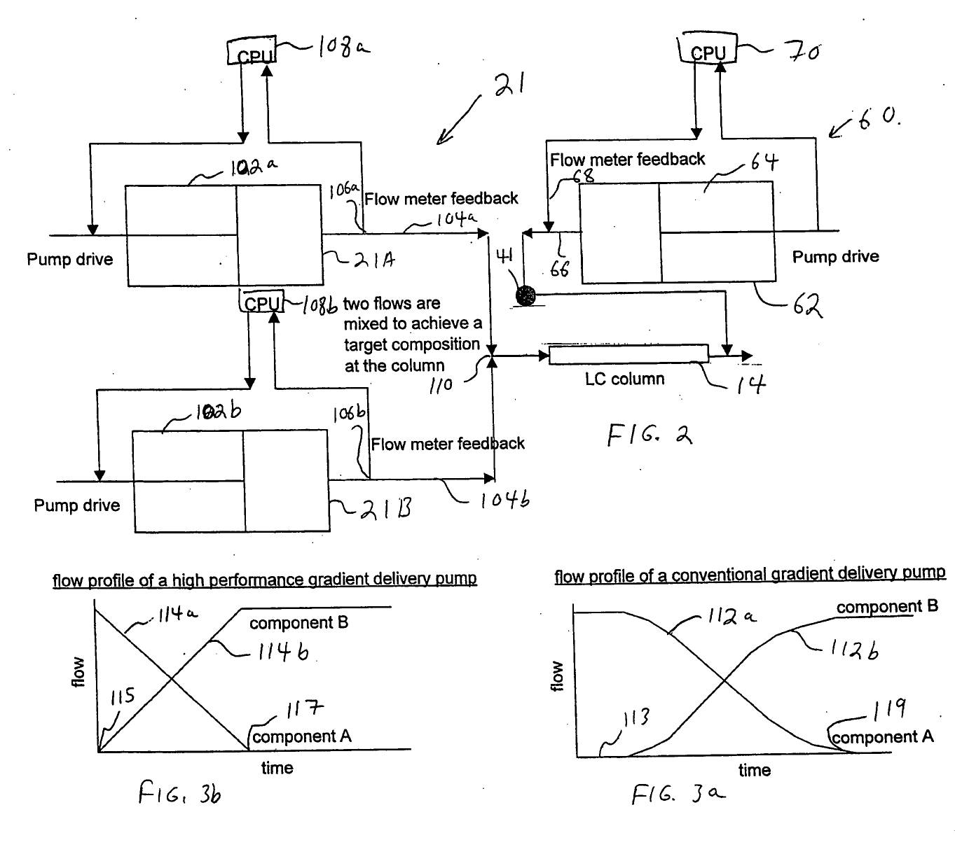

In particular, water from pump 21A is mixed in predefined amounts with solvent from pump 21B, as at 110, to form the eluant that flows at a controlled rate by the pumps 21A, 21B, respectively, into the respective liquid chromatography column 14. The pump system shown in FIG. 2 provides extremely precise gradient control. Having regard to FIGS. 3a, and 3b, it can be seen that the pumps 21A and 21B can be adjusted very quickly to mix the flow rates and provide a very precise and steep gradient.

For example, FIG. 3a shows the flow profile of a pump having a discontinuous flow rate, such as a piston driven pump that generates pulses of fluid flow. Line 112a illustrates the flow profile of water by such a pump, and line 112b illustrates the flow profile of a suitable solvent from a second piston driven pump. Line 112a shows that only water is initially channeled into the liquid chromatography column. After a period of time, as shown at 113, a predefined amount of solvent, as shown by line 112b, is then added to the mixture and proportionally the flow of the water is reduced over the same time so that the total flow rate of the entire system remains constant. Towards the end of the run, the amount of water introduced to the flow rate is minimal.

FIG. 3b shows the flow profile of pump 21, which, as previously described, allows for precise measurement of the flow rates and control of the flow of the eluants through respective chromatographic columns 14. Line 114a illustrates the flow profile of water by, for example, pump 21A, and line 114b illustrates the flow profile of a suitable solvent from pump 21B. Lines 114a and 114b reveal very steep gradients compared to lines 112a and 112b of FIG. 3a. For example, in FIG. 3b, the adding of solvent to the mixture commences generally immediately, as shown at 115 and increases very sharply. Similarly, the proportionate reduction of the water flow commences generally immediately. It can be appreciated that the flow rates between water and solvent as shown by lines 114a and 114b, respectively, is for illustrative purposes only, and that applicant's teachings contemplates additional fluid mixtures as well.

In addition to the very steep gradients shown by lines 114a and 114b compared to lines 112a and 112b, respectively, the precise and rapid control of fluid flow offered by pumps 21 allow for the particular fluid flow to commence generally immediately, as shown at 115 for line 114b in FIG. 3b, and, similarly, to stop generally immediately, as shown at 117 for line 114a in FIG. 3b. This can be compared to the gradual commencement of fluid flow as shown at 113 for line 112b in FIG. 3a, and similar gradual stopping of fluid flow as shown at 119 for line 112a in FIG. 3a.

It can be appreciated that a system to rapidly receive the discharged eluants from the chromatographic column or columns is needed to match the high throughput of the flowed eluants through the respective column or columns allowed for by the pump system previously described.

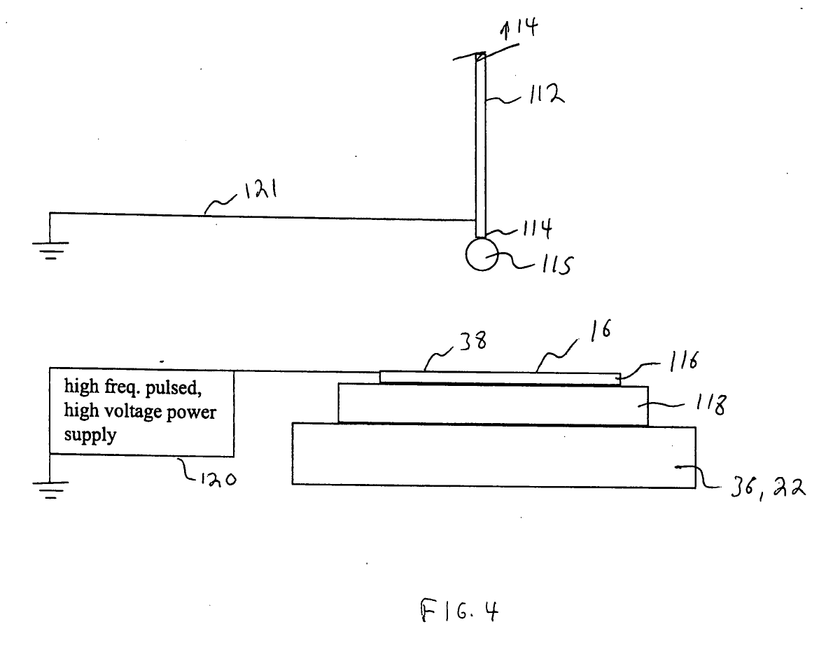

FIGS. 1a, 1b, and 4 show some aspects of applicant's teachings to collect discrete droplets of discharged eluants from respective chromatographic column 14 (FIG. 1a) or columns 14 (FIG. 1b) at high frequencies, generally equal to or greater than 10 Hz, and up to and including about 1 kHz, as will hereinafter be explained.

In particular, having regard to FIG. 4, the eluant from the chromatographic column 14 flows through capillary 112 to the discharge end 114 of the capillary. The discharge end 114 is spaced from facing 38 of the deposition surface 16. For purposes of scale and clarity, FIG. 4 illustrates an exaggerated spacing of the discharge end 114 from facing 38 of the deposition surface 16. It is to be understood, however, that the discharge end 114 of the capillary 112 is much closer to facing 38 of the deposition surface 16, as illustrated in FIGS. 1a and 1b.

The deposition surface 16 can be a plate 116, such as, the target plates used in MALDI analysis, and preferably microtiter plates. But other configurations of the deposition surface may be contemplated and include, but are not limited to a disk, tape, or drum. The facing 38 of the deposition surface 16 may include, but is not limited to, a metal surface consisting of stainless steel, gold, silver, chrome, nickel, aluminum, and copper. Moreover, the depositon surface 16, such as a target plate 116, may be removable from the array 22, for later analysis by MALDI mass spectrometry.

Plate 116 is typically held by suitable plate holder 118, which, in turn, can be supported by a motion table, such as a depositional array 22 (see FIG. 1). Moreover, as previously mentioned, the depositional array 22 can be provided on a translational stage 36, such as an x-y-z stage. The translational stage 36 is displaceable relative to the chromatographic column 14. It is understood that the depositional array 22, and hence the deposition surfaces 16, generally move relative to the chromatographic column 14 of FIG. 1a or chromatographic columns of 14 of FIG. 1b, however, alternatively the chromatographic column or columns 14 may move relative to the depositional array 22.

Referring to FIG. 4, the discharged eluant from the chromatographic column 14 forms a droplet 115 to be deposited to the deposition surface 16. Applicants teachings removes drop 115 from the discharge end 114 of the capillary 112 by providing an electric field between the deposition surface 16 and the droplet 115. This electric field acts to pull the droplet onto the deposition surface 16.

A suitable power supply 120 is provided to allow for adjustment of the output voltage. The power supply can include electrodes that are connected to ground or zero potential. The power supply is configured to energize either the deposition surface 16 or the droplet 115, to create a potential difference between the droplet and the deposition surface 16. For various embodiments of applicant's teachings, the deposition surface 16 is charged and the droplet 115 at the discharge end 114 of the capillary 112 is grounded as at 121.

A voltage pulse is provided to the deposition surface 16, and in this application, the voltage pulse creates a potential difference between the droplet and the deposition surface 16 to thereby pull the droplet 115 onto the deposition surface 16 and into a predesignated location, such as a well or divot 125 (see FIGS. 1a and 1b) provided in the facing 38 of the deposition surface 16. It can be appreciated that each of these wells or divots is an independently addressable target location and the deposition of the droplet into the suitable well or divot is controlled by a microprocessor that controls the relative position of the deposition surface 16 relative to the droplet 115 to be deposited.

The voltage pulse required to create a sufficient potential difference between the droplet and the deposition surface 16 to thereby pull the droplet 115 onto the deposition surface 16 and into a predesignated location, such as a well or divot 125 (see FIGS. 1a and 1b) is of the order of 1,000 volts per 0.2 mm, or about 5,000 volts per cm. At this voltage, relays are not an option because of the switching speed and the reliability of mechanical parts.

The voltage requirement can be achieved by a series arrangement of FET's or IGTB's (not illustrated) that are available in ratings of up to 1,200 volts. This divides the voltage across a number of devices. For example, and for purposes of illustration only, two sets of five FET's or IGTB's can be used to either connect the output to a 4,000-volt power supply or ground. The maximum voltage across each device is 800 volts, well within the maximum voltage rating. The devices are controlled so that they switch in unison by, for example, generating an RF signal at 8 Mhz and applying it to a coil printed on one side of the printed circuit board (not illustrated) of the FET's or IGTB's and detect this signal with another coil on the other side of the printed circuit board. This allows the control single to ride on top of whatever voltage is on the switching device. Op amps (not illustrated) can be used to generate the control signals. Moreover, a function generator (not illustrated) can be used for the internal clock, and a CMOS circuit (not illustrated) can be used for interlocking and application of the external pulse input.

In applicant's teachings, the voltage pulse to the different plates can be at very high frequencies, generally equal to or greater than 10 Hz, and up to and including about 1 kHz, thereby allowing extremely fast electrostatic deposition of the eluant onto the target plates of the deposition surface 16, which accommodates the high throughput of the eluant flows through the chromatographic column. Therefore an apparatus is provided that allows for a high throughput of depositing samples that can be analyzed by for example, but not limited to, MALDI mass spectrometry.

FIGS. 1a and 1b, also provides a MADLI matrix delivery system 40, that operates to deliver a matrix to the eluant in capillary 112 before the eluant is discharged from the capillary 112. The matrix is introduced through a load valve 41. The matrix delivery system is described in greater detail below in relation to some aspects of applicant's teachings.

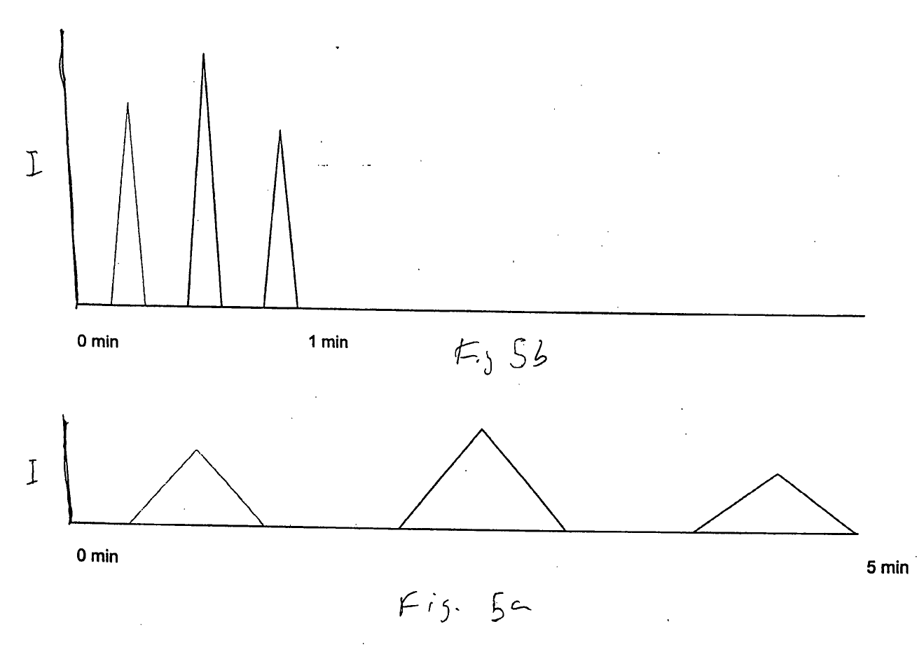

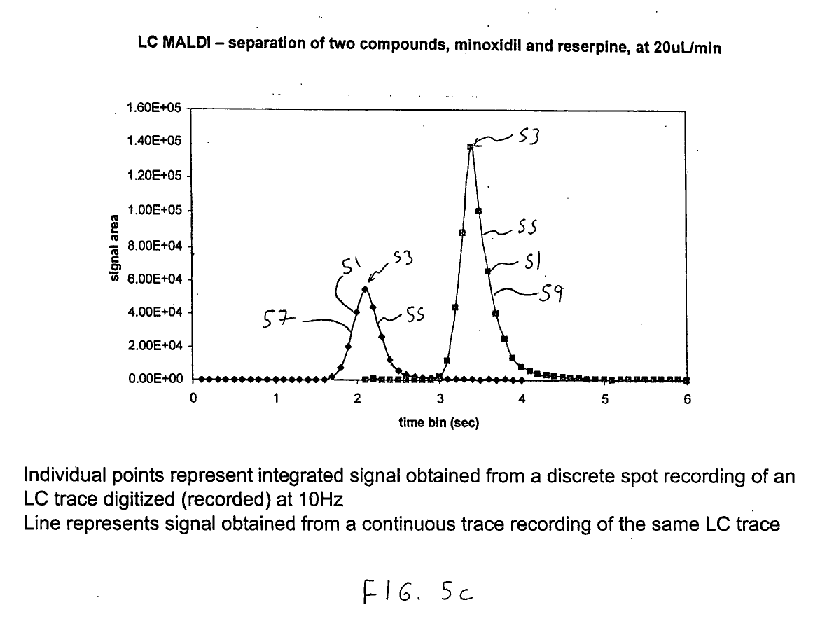

FIGS. 5a and 5b illustrate how the combination of the pumping system to achieve high throughput flow rates and the deposition system described, at frequencies generally equal to or greater than 10 Hz, and up to and including about 1 kHz, produce chromatograms that, when analyzed, produce sharper peaks in shorter run times. For example, FIG. 5a illustrates signal traces of three compounds separated using conventional pumping and deposition technologies. The run times to achieve the peaks are seen to be upwards of five minutes.

FIG. 5b shows a similar run using the pumping system and deposition techniques in accordance with the applicant's teachings. The run time is seen to be less than one minute, which is five times faster than that obtained using conventional methods. As a result, the samples for analysis are more concentrated resulting in sharper peaks. Applicant's teachings provides a dramatic increase in throughput and detectability.

FIG. 5c shows a signal trace from LC MADLI for the separation of minoxidil (trace 57) and reserpine (trace 59) at 20 μL/minute using the deposition described for FIGS. 1a and 1b and run at a rate of about 10 Hz. The individual points from the discrete droplets recorded are shown in FIG. 5c as at 51. The sharp peaks illustrated, as at 53, attest to the increase in throughput and detectability when using applicant's teachings.

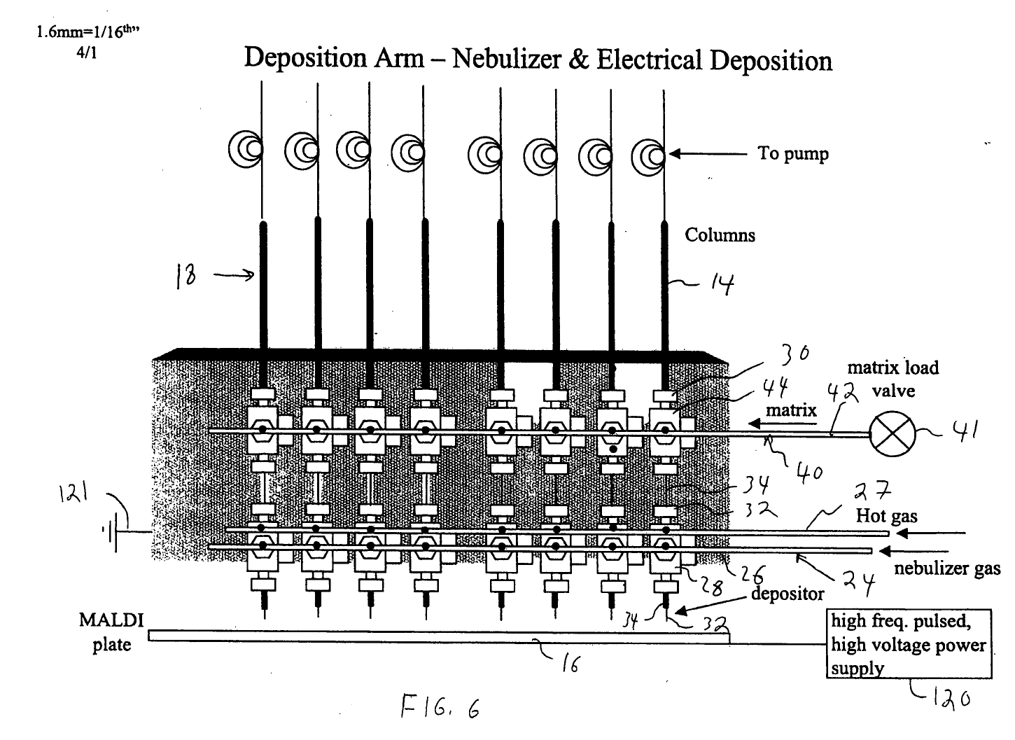

FIG. 6 illustrates some aspects of applicant's teachings that provides for rapid and continuous sample deposition. The results from the various embodiments are also shown in FIG. 5c, and are represented by the line 55 that represents a signal obtained from a continuous trace recording of the individual points from the discrete droplets recorded as at 51.

In particular, FIG. 6, adds a nebulizer 24 to introduce a nebulizing gas to the chromatographic columns 14 to nebulize the eluants in the chromatographic columns as they are being discharged from the chromatographic columns. The nebulizer gas evaporates the eluants in the chromatographic columns 14. The discharged nebulized eluants are deposited onto the deposition surface 16.

The nebulizer gas is a non-reactive gas, and may include, but is not limited to, nitrogen, dried air, the noble gases, or any other appropriate gas. It is understood that other means to nebulize the samples are possible and are well known in the art.

The nebulizer 24 includes a manifold 26 connected to the chromatographic columns 14 to deliver the nebulizing gas to the eluants in the chromatographic columns 14. In some embodiments, the manifold 26 is a tubing manifold. As illustrated in FIG. 6, T-valves 28 connect the manifold 26 to the multiple chromatographic columns 14 to allow the introduction of the nebulizing gas to the chromatographic columns 14. Nebulizing of the eluants occurs as the eluants are discharged from the chromatographic columns 14, so, in some embodiments, the manifold 26 that delivers the nebulizer gas is connected by the T-valves 28 at or near the discharge end 30 of the chromatographic columns 14. It is to be understood that for purposes of illustration, FIG. 6 shows an apparatus adapted to prepare multiple chromatograms 12 for analysis by a MALDI mass spectrometer, and therefore features an additional matrix manifold, as will hereinafter be explained, between the end 30 of the chromatographic columns 14 and the T-valves 28 of the nebulizer 24. For purposes of this application, the discharge end of the chromatographic columns 14 can encompass the discharge from the chromatographic columns or the discharge from, for example, a matrix delivery system, if present, or any other delivery system that could be present before the nebulizer 24.

The T-valves 28 of the nebulizer 24 can be operably connected at discharge end 32 to deposition capillaries 34. Deposition capillaries 34 discharge the nebulized eluants from the respective multiple chromatographic columns 14 to the suitable surface 16. The deposition capillaries can operate 1-5 mm from the suitable surface, which is not shown in FIG. 6 for clarity.

The nebulizer 24 further includes a pump (not shown) to deliver the nebulizing gas to the chromatographic columns 14. In some embodiments of applicant's teachings the pump comprises a pneumatic pump, but applicant's teachings is not intended to be limited to such a pump.

The discharged eluant may also be heated to accelerate desolvation by the nebluizer 24. As illustrated in FIG. 6, the discharged eluant is heated by flowing, as at 27, a suitable heated gas from a source to the T-valves 28. It can be appreciated, however, that other methods and structures for heating the discharged eluants are contemplated by applicant's teachings.

FIG. 6 illustrates a matrix delivery system 40 for when the chromatograms 12 are analyzed by MALDI mass spectrometry. The matrix delivery system 40 can include a manifold 42 connected to the chromatographic columns 14 to introduce a matrix to the eluants. For the some embodiments respective T-valves 44 connect the manifold 42 to the chromatographic columns 14.

The T-valves 44 can be operably connected to the chromatographic columns 14 to deliver the matrix to the eluants before the eluants are nebulized by the nebulizer 24 (see FIG. 6). The matrix delivery system can include a pump 60 system (illustrated schematically in FIG. 2 to deliver the matrix to the load valve 41, and then through the manifold 42 and T-valves 44, to the chromatographic columns 14. The pump can be, for example, a syringe pump, or alternatively, but not limited to, a continuous flow pump.

FIG. 2 schematically illustrates a suitable pump system 60 for delivering the matrix. System 60 comprises a pump 62 featuring a source 64 of matrix and a discharge channel 66 connected to the source and through which the matrix travels to the load valve 41 and ultimately chromatographic column 14. Flow meter 68 is provided in channel 66 to measure the flow rate of the matrix through channel 66. The fluid flow rate measured by the flow meter 68 is monitored by a control processor 70, which adjusts the discharge of the matrix from source 64.

The appropriate matrix materials for use in MALDI are well known in the art. Examples of commonly used matrix materials include, but are not limited to, 2,5-dihydroxybenzoic acid derivatives, sinapinic acid derivatives, and indoleacrylic acid derivatives.

As shown in FIG. 7, the nebulized eluants with eluted separated components of the samples are discharged to at least one depostion surface 16, to produce multiple chromatograms 12, as shown, for example on surface 16a. However, since the deposition array 22 can carry multiple surfaces 16 in a translation stage 36, the method can produce mutiple chromatograms simultaneously on a plurality of surfaces, and in particular surface 16a and 16b as shown in FIG. 7.

As best illustrated in FIG. 7 the apparatus and method of applicant's teachings produces multiple chromatograms 12 deposited onto the suitable surfaces 16 that can be in continuous and uninterrupted traces. Although the traces of the chromatograms 12 in FIG. 7 are generally parallel to one another, it can be appreciated, however, that the continuous traces may be deposited in any line or any pattern.

In addition, the deposition of the chromatograms 12 can be formed in continuous, uninterrupted traces that are uniform and void of gaps. The homogeneity of the continuous traces preserves an intact signal without loss of data, accuracy, and chromatographic fidelity when the chromatogram 12 is subject to analysis by MALDI mass spectrometry.

Where the method of applicant's teachings is used to prepare the multiple chromatograms for analysis by mass spectrometry, all or a portion of a select chromatogram 12 from the apparatus, as described above for FIGS. 1a, 1b, and 6, is ionized and then the ions analyzed by mass spectrometer (not illustrated). In particular, the chromatograms are suitable for soft ionization mass spectrometry, such as, for example, but not limited to MALDI.

For MALDI it is preferable to use a high-repetition nitrogen laser (not illustrated) to irradiate and ionize all or a portion of a select chromatogram 12. It can be appreciated, however, that any type of laser could be used so long as its output can span the energy range of about 0.1 microjoules per pulse to about 100 microjoules per pulse, suitable for MALDI applications. Preferably, each trace is rastered at a constant velocity so as to image the chromatogram at high chromatographic resolution when analyzed by mass spectrometry.

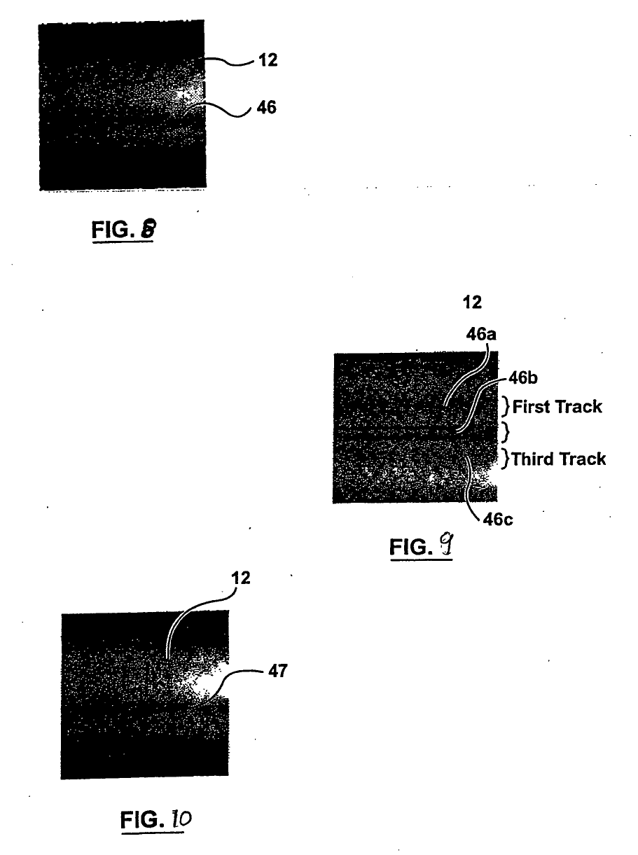

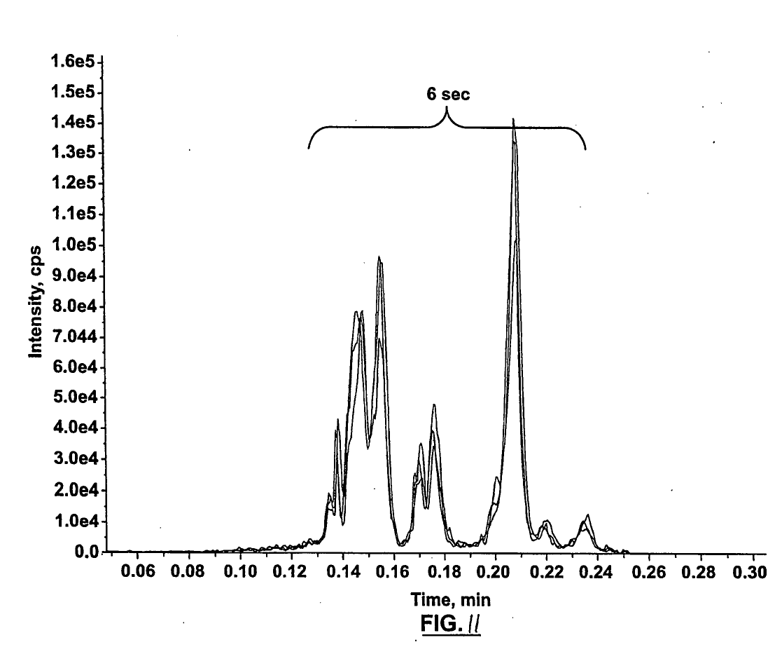

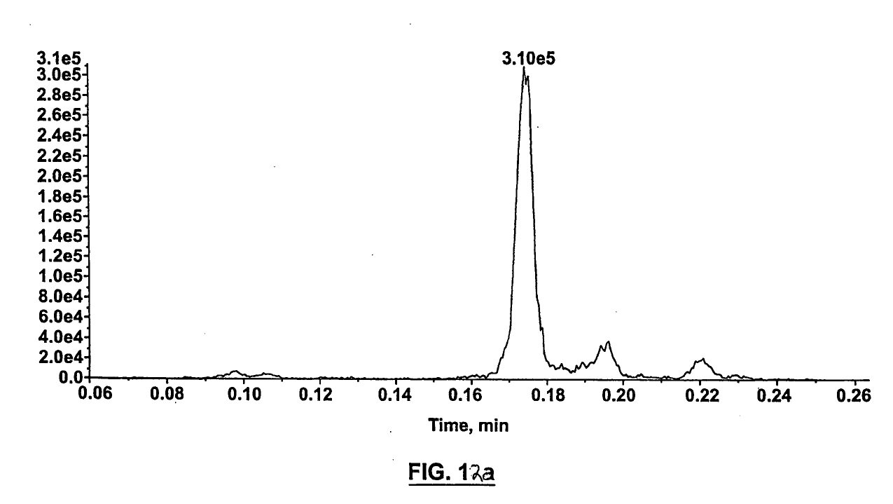

As illustrated in FIG. 8, the laser can be operated to produce at least one track 46 on the continuous trace of a select chromatogram 12. It can be appreciated, however, that multiple laser tracks 46a, 46b, 46c, can be produced on a single continuous trace of the select chromatogram 12—as illustrated in FIG. 9. Alternatively, however, multiple laser passes can be made on a single track 47 produced on the continuous trace of a selected chromatogram 12 (see FIG. 10).

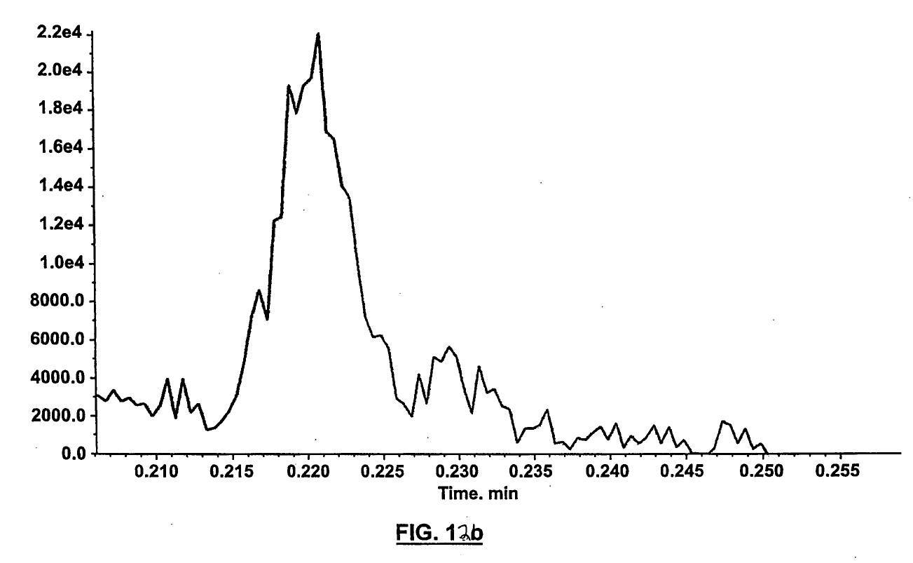

FIG. 11 shows an example of exemplary reproducibility when multiple passes are conducted on the same laser track 47 on the select chromatogram 12 (as illustrated in FIG. 10). The data resulting from the first, third, and fifth passes over the same track is shown over a 6 second interval. By conducting multiple passes of the same sample, there is a considerable savings in time since the sample does not have to be re-prepared and small amounts of sample are sufficient for analysis. In addition, the chromatograms may be stored for re-analysis.

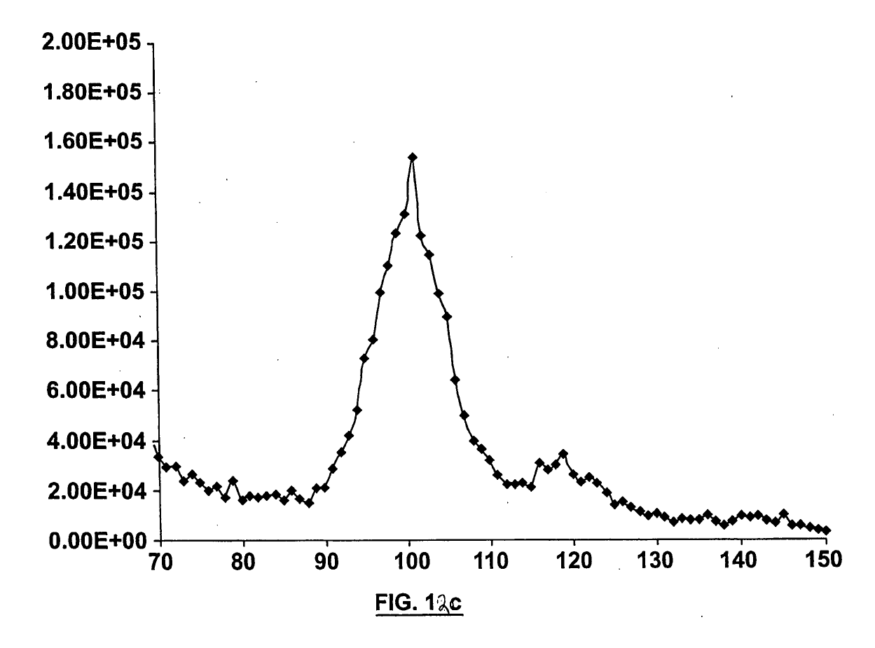

FIGS. 12a, 12b, 12c show the detection limit enhancement by summing multiple passes over the same laser track 47 on the select chromatogram 12. For these Figures, eight single passes over the same laser track are added together. It is found that there is approximately a four times improvement in signal-to-noise ratio in comparison to a single laser pass. Furthermore, this represents only 20 percent of the total recoverable signal from a select chromatogram 12, since additional laser tracks are possible on the select chromatogram (see, for example, FIG. 9).

The system shown in FIG. 6 combines high frequency electrodeposition and a nebulizer. This allows the system of FIG. 6 to achieve a throughput beyond that which can be achieved with parallelization alone; fast chromatographic peaks require high-resolution deposition techniques. The apparatus and systems described above would apply generally to all types of liquid chromatographs and can be used for all types of desorption ionization, including MALDI. For example, in the device of FIG. 6, the nebulizer can be shut-off and through use of a suitable power source 120, a voltage pulse can be applied to the deposition surface 16 so that the device is operated in electrostatic mode with extremely fast discrete droplet deposition.

Alternatively, the power source can be shut-off and a nebulizing gas can be introduced through nebulizer 24 to nebulize the eluants in the chromatographic columns that can produce a generally continuous trace.

Therefore, the various embodiments of FIG. 6 can achieve high resolution digitization by pulsing the fluid emanating from the chromatographs by applying a voltage to the target plate that operates at frequencies equal to or greater than about 10 Hz, and up to and including about 1 KHz. Various embodiment of FIG. 6 also allows for analogue recording (i.e., approaching infinite resolution) by nebulizing the fluid coming from the columns and simultaneously collecting it on a target plate as a continuous trace.

Moreover, sample throughputs can be increased by recording multiple chromatograms simultaneously and to allow the individual chromatographs to be operated at high speed thereby producing sample transients that are less than one second in duration from multiple chromatographs simultaneously. Recording of the transients (chromatographic peaks) in a digital fashion (spotting) requires high frequency sampling in order to retain the data integrity and in situations where sample transients (peaks) are extremely fast analogue recording may be invoked.

The records of such chromatograms can be read by using a mass spectrometer with, for example, MALDI ionization, or any other forms of ionization, including fast atom bombardment, secondary ion mass spectrometry (SIMS), thermal desorption with electron impact, photoionization, desorption electrospray (DESI), atmospheric pressure chemical ionization, or other means of ionizing compounds from a surface.

While the applicant's teachings are described in conjunction with various embodiments, it is not intended that the applicants teachings be limited to such various embodiments. On the contrary, the applicant's teachings encompass various alternatives, modifications, and equivalents, as will be appreciated by those of skill in the art.

1. A method of depositing a sample for analysis, the method comprising:
a) flowing a suitable eluant through a chromatographic column for separating a sample;
b) discharging from the chromatographic column the eluant with eluted separated components of the sample, the eluant forming a droplet at the discharge end of the chromatographic column;
c) providing a suitable deposition surface spaced from the discharge end of the chromatographic column to receive the droplet; and
d) applying a voltage to the deposition surface to pull the droplet to the deposition surface.

2. The method of claim 1, wherein the voltage is applied to the deposition surface at a frequency up to and including generally 1 kHz.

3. The method of claim 1, wherein at least one pneumatic pump is used to flow the suitable eluant through the chromatographic column.

4. The method of claim 1, wherein the eluant flow rate is controlled by a flow meter in combination with a control processor, the eluant flow rate measured and controlled to provide continuous control of the flow rate.

5. The method of claim 1, wherein the eluant flow rate is a mixture of two fluid flows, with the flow rate of each fluid flows controlled by a respective flow meter in combination with a control processor.

6. The method of claim 5, wherein at least one of the fluid flows is water.

7. The method of claim 6, wherein the other of the fluid flows is a solvent.

8. The method of claim 1, wherein the voltage is applied to the deposition surface so that successive droplets are pulled to corresponding target locations on the deposition surface.

9. The method of claim 8, wherein the deposition surface is movable relative to the discharge end of the chromatographic column.

10. The method of claim 1, further comprising introducing a matrix to the sample, the matrix suitable for use in matrix-assisted laser desorption ionization.

11. A method of depositing multiple samples for analysis, the method comprising:
a) flowing suitable eluants through respective multiple chromatographic columns, each column for separating a sample;
b) discharging from the multiple chromatographic columns the eluants with eluted separated components of the samples, the eluants forming droplets at the discharge ends of the respective chromatographic columns;
c) providing at least one suitable deposition surface spaced from the discharge ends of the chromatographic columns to receive the droplets; and
d) applying a voltage to the deposition surface to pull the droplets to the deposition surface.

12. The method of claim 11, wherein the voltage is applied to the deposition surface at a frequency up to and including generally 1 kHz.

13. The method of claim 11, wherein at least one pneumatic pump is used to flow the suitable eluant through the chromatographic columns.

14. The method of claim 11, wherein a plurality of pneumatic pumps is provided, and at least one pump is associated with each respective chromatographic column.

15. The method of claim 11, wherein the eluant flow rate for each chromatographic column is controlled by a respective flow meter in combination with a control processor, the eluant flow rates for each respective chromatographic column independently measured and controlled to provide continuous control of the flow rate for each column.

16. The method of claim 11, wherein each eluant flow rate for each chromatographic column is provided by mixing two fluid flows, with each fluid flow rate controlled by a respective flow meter in combination with a control processor.

17. The method of claim 16, wherein at least one of the fluid flows is water.

18. The method of claim 17, wherein the other of the fluid flows is a solvent.

19. The method of claim 11, wherein the voltage is applied to the deposition surface so that successive droplets are pulled to corresponding target locations on the deposition surface.

20. The method of claim 19, wherein the deposition surface is movable relative to the discharge ends of the chromatographic columns.

21. The method of claim 11, further comprising introducing a matrix to the sample, the matrix suitable for use in matrix-assisted laser desorption ionization.

22. The method of depositing multiple sample for analysis, the method comprising:
a) flowing suitable eluants through multiple chromatographic columns, each column for separating a sample;
b) discharging from the multiple chromatographic columns the eluants with eluted separated components of the samples;
c) nebulizing the discharged eluants; and
d) depositing the nebulized eluants on at least one suitable deposition surface to produce chromatograms.

23-40. (canceled)

41. An apparatus to prepare a sample for analysis, the apparatus comprising:
a) a chromatographic column to receive a sample with a suitable eluant;
b) a pump to flow the eluant through the chromatographic column;
c) a suitable deposition surface, the deposition surface spaced from a discharge end of the chromatographic column to receive a droplet formed at the end thereof by the flow of eluant through the chromatographic column; and
d) a power supply to generate a voltage on the deposition surface to pull the droplets to the deposition surface.

42-52. (canceled)

53. An apparatus to prepare multiple samples for analysis, the apparatus comprising:
a) multiple chromatographic columns to receive at least one sample with a suitable eluant;
b) a plurality of pumps, with each pump associated with each chromatographic column, the pump to flow the eluant through the chromatographic column, the pump further including a flow meter and control processor to provide continuous control of the eluant flow rate;
c) at least one suitable deposition surface, the deposition surface spaced from multiple discharge ends of the respective chromatographic columns, the at least one suitable deposition surface to receive droplets formed at the ends thereof by the flow of eluants through the respective chromatographic columns; and
d) at least one power supply to generate a voltage on the deposition surface to pull the droplets to the deposition surface.

54-74. (canceled)

75. An apparatus to prepare multiple samples for analysis, the apparatus comprising:
a) multiple chromatographic columns to receive at least one sample with a suitable eluant;
b) a plurality of pumps, with each pump associated with each chromatographic column;
c) a nebulizer to introduce a nebulizing gas to the multiple chromatographic columns, the nebulizer nebulizing the flow of eluants as they are discharged; and
d) at least one suitable deposition surface to receive the discharged nebulized eluants, the discharged nebulized eluants from the multiple chromatographic columns producing respective multiple chromatograms on the at least one suitable deposition surface.

76-96. (canceled)

97. A system to prepare multiple samples for analysis through droplet deposition or by nebulizing, depending on use, the system comprising:
a) multiple chromatographic columns to receive at least one sample with a suitable eluant;
b) a plurality of pumps, with each pump associated with each chromatographic column;
c) a nebulizer to introduce a nebulizing gas to the multiple chromatographic columns, the nebulizer nebulizing the flow of eluants as they are discharged;
d) at least one suitable deposition surface to receive the discharged nebulized eluants, the discharged nebulized eluants from the multiple chromatographic columns producing respective multiple chromatograms on the at least one suitable deposition surface; and
e) at least one power supply to generate a voltage on the deposition surface to pull the droplets to the deposition surface.

98-117. (canceled)

118. The method of claim 1, wherein the voltage applied to the deposition surface at a frequency generally equal to or greater than 10 Hz.

119. The method of claim 11, wherein the voltage applied to the deposition surface at a frequency generally equal to or greater than 10 Hz.
